(19) United States
(12) Patent Application Publication
(10) Pub. No.: US 2023/0286349 A1
(43) Pub. Date: Sep. 14, 2023

(54) TORSION BEAM SUSPENSION

(71) Applicant: Honda Motor Co., Ltd., Tokyo (JP)

(72) Inventor: Hisashi ISHIMATSU, Saitama (JP)

(73) Assignee: Honda Motor Co., Ltd., Tokyo (JP)

(21) Appl. No.: 18/168,578

(22) Filed: Feb. 14, 2023

(30) Foreign Application Priority Data
Mar. 14, 2022 (CN) 202210246801.0

(51) Int. Cl. B60G 21/05

(52) U.S. Cl. CPC B60G 21/052; B60G 2200/21; B60G 2204/143

(57) ABSTRACT

A torsion beam suspension includes two trailing arm portions, in which each of the trailing arm portions includes an elastic supporting portion and an extending portion, and the extending portion extends from the elastic supporting portion toward an inner side of a vehicle body in a width direction, and a torsion beam fixed to the extending portion of each of the trailing arm portions.

### CROSS-REFERENCE TO RELATED APPLICATION

This application claims the priority benefit of China application serial no. 202210246801.0, filed on Mar. 14, 2022. The entirety of the above-mentioned patent application is hereby incorporated by reference herein and made a part of this specification.

### BACKGROUND

### Technical Field

The disclosure relates to a suspension, and more particularly, to a torsion beam suspension.

### Description of Related Art

In recent years, the importance of improving the quality of the transportation system has been increasing in consideration of vulnerable groups such as the elderly and children among the traffic participants. To achieve this goal, efforts must be made to improve developments related to the behavioral stability of vehicles to further enhance traffic safety and convenience. In the development related to the behavior stability of the vehicle, the vehicle is provided with a torsion beam between a left wheel and a right wheel, which may avoid the reduction of ride comfort due to twisting of a vehicle body when the vehicle is running on an uneven road, and may resist lateral force when the vehicle is turning to improve the stability of the turning. However, the torsion beam is liable to bend due to the lateral force, and required characteristics of a toe angle and lateral stiffness of a ground point may not be obtained. Therefore, it is necessary to improve the torsion beam to overcome the above issues.

### SUMMARY

The disclosure provides a torsion beam suspension, including two trailing arm portions, in which each of the trailing arm portions includes an elastic supporting portion and an extending portion, and the extending portion extends from the elastic supporting portion toward an inner side of a vehicle body in a width direction, and a torsion beam fixed to the extending portion of each of the trailing arm portions.

In order for the aforementioned features and advantages of the disclosure to be more comprehensible, embodiments accompanied with drawings are described in detail below.

### BRIEF DESCRIPTION OF THE DRAWINGS

FIG. 1 is a top view of a torsion beam suspension according to an embodiment of the disclosure.

FIG. 2 shows a trailing arm portion in FIG. 1.

### DETAILED DESCRIPTION OF DISCLOSED EMBODIMENTS

The disclosure provides a torsion beam suspension, which may improve a capacity of a torsion beam to resist lateral force.

The disclosure provides a torsion beam suspension, including two trailing arm portions, in which each of the trailing arm portions includes an elastic supporting portion and an extending portion, and the extending portion extends from the elastic supporting portion toward an inner side of a vehicle body in a width direction, and a torsion beam fixed to the extending portion of each of the trailing arm portions.

In an embodiment of the disclosure, each of the trailing arm portions further includes a vehicle body fixing portion and an inclination portion. The vehicle body fixing portion extends from the extending portion toward a front of the vehicle body and is fixed to the vehicle body. The inclination portion is inclined from the vehicle body fixing portion toward the inner side of the vehicle body in the width direction and is connected to the extending portion.

In an embodiment of the disclosure, a material of each of the trailing arm portions includes aluminum, and a material of the torsion beam includes iron.

Based on the above, in the torsion beam suspension of the disclosure, the torsion beam and the trailing arm portion are not integrally formed, and the trailing arm portion has the extending portion extending toward the inner side of the vehicle body in the width direction for fixing to the torsion beam. As a result, the length of the torsion beam in the width direction of the vehicle body is reduced, and the structural strength and stiffness thereof may be improved, so that it is not easy to bend due to the lateral force. Therefore, the torsion beam suspension of the disclosure may improve the capacity of the torsion beam to resist the lateral force.

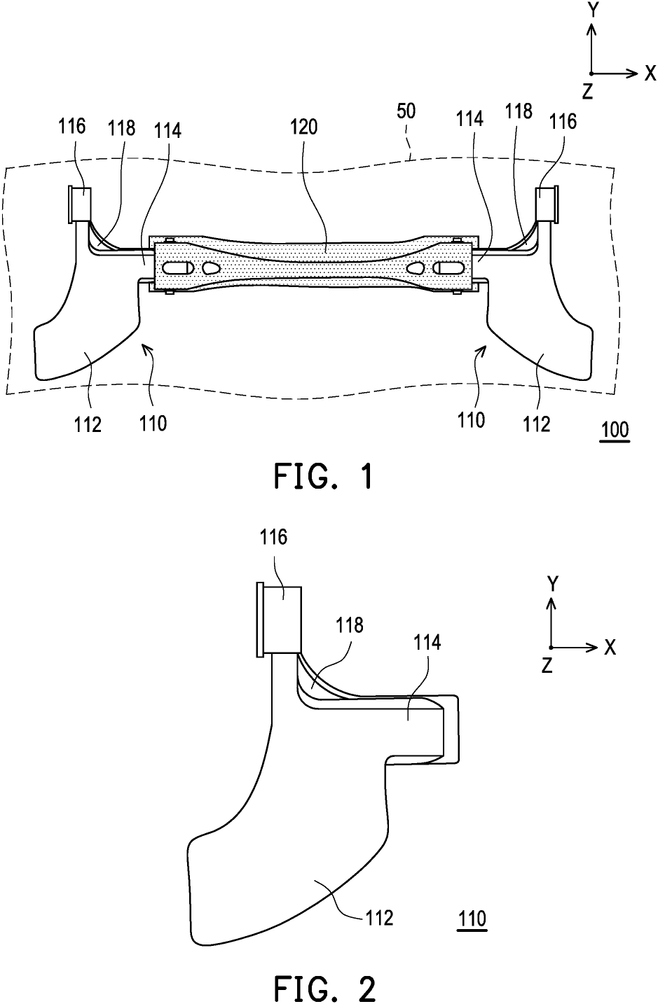

FIC. 1 is a top view of a torsion beam suspension according to an embodiment of the disclosure, in which axes X, Y, and Z are marked. Referring to FIG. 1, a torsion beam suspension 100 in this embodiment is, for example, disposed between a left wheel and a right wheel of a vehicle, and includes two trailing arm portions 110 and a torsion beam 120. The trailing arm portions 110 are disposed in pairs on left and right sides of a vehicle body 50 and respectively connected to the left wheel and the right wheel. Two ends of the torsion beam 120 are respectively connected to the two trailing arm portions 110. The torsion beam 120 may prevent the vehicle body from being twisted to reduce ride comfort when the vehicle is running on an uneven road, and may resist lateral force (such as force parallel to the axis X) when the vehicle is turning to improve turning stability.

FIG. 2 shows a trailing arm portion in FIG. 1. Referring to FIGS. 1 and 2, each of the trailing arm portions 110 in this embodiment includes an elastic supporting portion 112, an extending portion 114, and a vehicle body fixing portion 116. The extending portion 114 extends from the elastic supporting portion 112 toward an inner side of the vehicle body 50 in a width direction (i.e., a direction parallel to the axis X), and the torsion beam 120 is fixed to the extending portion 114 of each of the trailing arm portions 110. That is, the two ends of the torsion beam 120 are respectively fixed to the two extending portions 114. In this embodiment, the torsion beam 120 and the extending portion 114 are fixed to each other by, for example, screw locking or other appropriate assembly methods, and the disclosure is not limited thereto. The vehicle body fixing portion 116 extends from the extending portion 114 toward a front of the vehicle body 50 and is fixed to the vehicle body 50.

In the above configuration, the torsion beam 120 and the trailing arm portion 110 are not integrally formed. The trailing arm portion 110 has the extending portion 114 extending toward the inner side of the vehicle body 50 in the width direction for fixing to the torsion beam 120. As a result, a length of the torsion beam 120 in the width direction of the vehicle body 50 is reduced, and structural strength and stiffness thereof may be improved, so that it is not easy to bend due to the lateral force. Therefore, the torsion beam suspension 100 in this embodiment may improve a capacity of the torsion beam 120 to resist the lateral force, avoiding the bending of the torsion beam 120 due to the lateral force, so as to maintain required characteristics of a toe angle and lateral stiffness of a ground point.

In the torsion beam suspension 100 in this embodiment, a material of the two trailing arm portions 110 is, for example, aluminum, so that the trailing arm portions 110 have a relatively small weight and may be manufactured into an integrally formed structure. A material of the torsion beam 120 is, for example, iron, so that the torsion beam 120 has the sufficient structural strength and stiffness. In other embodiments, the trailing arm portions 110 and the torsion beam 120 may be manufactured by other types of materials respectively, and the disclosure is not limited thereto.

In this embodiment, each of the trailing arm portions 110 further includes an inclination portion 118. The inclination portion 118 is inclined from the vehicle body fixing portion 116 toward the inner side of the vehicle body 50 in the width direction and is connected to the extending portion 114. By forming the inclination portion 118 between the vehicle body fixing portion 116 and the extending portion 114, the trailing arm portion 110 may be prevented from extending outward in the width direction of the vehicle body 50 due to the lateral force, thereby maintaining the good characteristics of the toe angle and lateral stiffness of the ground point.

Based on the above, in the torsion beam suspension of the disclosure, the torsion beam and the trailing arm portion are not integrally formed, and the trailing arm portion has the extending portion extending to the inner side of the vehicle body in the width direction for fixing to the torsion beam. As a result, the length of the torsion beam in the width direction of the vehicle body is reduced, and the structural strength and stiffness thereof may be improved, so that it is not easy to bend due to the lateral force. Therefore, the torsion beam suspension of the disclosure may improve the capacity of the torsion beam to resist the lateral force.

Finally, it should be noted that the above embodiments are only used to illustrate but not to limit the technical solutions of the disclosure. Although the disclosure has been described in detail with reference to the foregoing embodiments, persons skilled in the art should understand that they may still modify the technical solutions described in the foregoing embodiments or equivalently replace some or all of the technical features. However, the modifications or replacements do not cause the spirit of the corresponding technical solution to deviate from the scope of the technical solution according to each embodiment of the disclosure.

What is claimed is:

1. A torsion beam suspension, comprising:
two trailing arm portions, wherein each of the trailing arm portions comprises an elastic supporting portion and an extending portion, and the extending portion extends from the elastic supporting portion toward an inner side of a vehicle body in a width direction; and
a torsion beam fixed to the extending portion of each of the trailing arm portions.

2. The torsion beam suspension according to claim 1, wherein
each of the trailing arm portions further comprises a vehicle body fixing portion and an inclination portion, the vehicle body fixing portion extends from the extending portion toward a front of the vehicle body and is fixed to the vehicle body, and the inclination portion is inclined from the vehicle body fixing portion toward the inner side of the vehicle body in the width direction and is connected to the extending portion.

3. The torsion beam suspension according to claim 2, wherein
a material of each of the trailing arm portions comprises aluminum, and a material of the torsion beam comprises iron.
